(19) United States
(12) Patent Application Publication
(10) Pub. No.: US 2004/0222894 A1
(43) Pub. Date: Nov. 11, 2004

(54) Plant water alarm

(76) Inventor: Douglas Cass, Langley (CA)

Correspondence Address: Douglas Cass, 21515 18 Ave., Langley, BC, V222C1, CA

(21) Appl. No.: 10/430,232

(22) Filed: May 7, 2003

(51) Int. Cl. G08B 21/00

(52) U.S. Cl. 340/602; 340/604

(57) ABSTRACT

The purpose of this Plant Water Alarm is to provide a low cost visual and audible Alarm of low moisture level in domesticated plants or other.

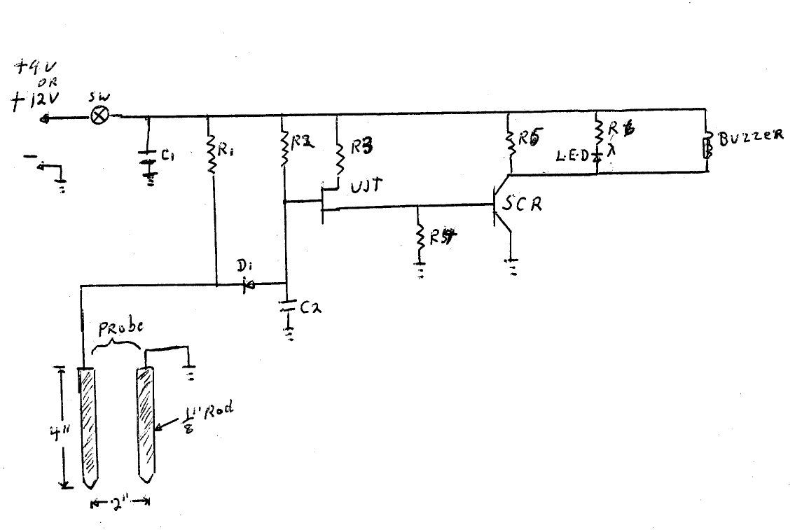

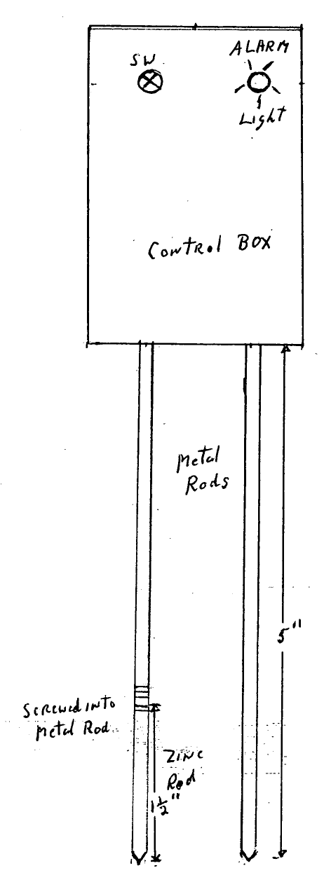

At this time I have found no plant supplier having a moisture level alarm available.

The Plant Water Alarm is a device with its control circuit enclosed In a box or container with two 4 inch rods ⅛ of an inch thick spaced 2 inches apart sticking out the bottom which are inserted into the soil of the plant being monitored.

There is a switch on the box, which turns the device on or off.

When the water content gets low in the plant the circuit turns on and causes a flashing L.E.D to light and a buzzer to come on.

The system runs on a 12 volt A.C. Adaptor providing 12 volts D. C. which I find to be the simplest and cheapest.

The system could also run on a nine-volt battery or 12 volt battery, which would be included in the control box. The life span of the battery can be increased considerably by installing a timer ahead of the control circuit or as a part of it which turns on the voltage to the control circuit on say every three or four hours for a few minutes at a time. Once the circuit is triggered by a lack of moisture the L.E.D. and Buzzer come on and stay on till the circuit is turned off by the switch.

Once the water is added to the plant the circuit can be turned back on with the switch and the plant is being monitored again.

### PLANT WATER ALARM PARTS LIST

Battery or AC Adapter 12 V or 9 V

Sw—SPST Switch

C1—100 ufd/50V

C2—50 micro Farad

R1—22 K Ohms—This resistor can be a variable resistor to adjust the Sensitivity of the plant water alarm, by reducing the value of R1, the point where the alarm can come on when water content is higher can be set. I found 22 k to be the best.

R2—15 K Ohms

R3—100 Ohms

R4—47 Ohms

R5—1 k Ohms

R6—1 k Ohms

D1—Diode 1N87

UJT—Unijunction Transistor MU10

SCR—106B1

L.E.D.—Pulsing L.E.D.

Buzzer—12v or 9 V D.C. This could be of pulsing variety

Probe-2—⅛ In Nickel Plated Steel Rods 4 in Long 2 inches apart Mounted on the box containing the alarm Circuit

### BRIEF SUMMARY OF INVENTION

The purpose of this Plant Water Alarm is to provide a low priced visual and audible indication of low moisture level in plants

This provides a very good method of preventing plants from dying from lack of attendance to their water requirements.

It would be good for blind people, who could hear the buzzer and For those hard of hearing who could see the flashing light.

The circuit with additions could transmit a signal to a remote location to monitor the moisture or to activate a watering system.

This would be useful in a space station growing plants for food in being able to control the moisture level automatically without attendance.

Although this is a fairly well known control circuit, the application of it to a plant water alarm I believe is new and a patent should be allowed.

I have checked all the plant supply houses and found none with a alarm device for plants for lack of water, all they have is a device to show the water content in the soil.

I use a 12 volt A.C. Adapter to supply D.C voltage for the control circuit. A nine volt A. C. Adapter would work just as easily. I find this to be the easiest and cheapest way.

Although not shown a timer circuit could be used in addition By supplying voltage to the control circuit for a few minutes every three or four hours in order to save battery life, if battery only is used.

This device would be useful for people who are hard of hearing The buzzer would alert those who are blind and the flashing L.E.D. would alert normal people and those hard of hearing by seeing the flashing L.E.D. Thus protecting their valuable plants

This device would prevent the dying of valuable plants for lack of water. Further it would prevent over watering of plants.

1. I believe that I am the original and first inventor of the subject matter which is claimed for and which a patent is sought.
